(19) United States
(12) Patent Application Publication
(10) Pub. No.: US 2013/0199570 A1
(43) Pub. Date: Aug. 8, 2013

(54) CLEANING ROBOT SYSTEM AND ITS METHOD FOR CONTROLING

(71) Applicants: Man-Hee Lee, Seongbuk-gu (KR); Ki-Yong Lee, Seongnamsi (KR); Chang-Nam Song, Yeongdeungpo-gu (KR)

(72) Inventors: Man-Hee Lee, Seongbuk-gu (KR); Ki-Yong Lee, Seongnamsi (KR); Chang-Nam Song, Yeongdeungpo-gu (KR)

(73) Assignee: Moneual Inc., Seoul (KR)

(21) Appl. No.: 13/825,150

(22) PCT Filed: Apr. 27, 2011
(86) PCT No.: PCT/KR11/03072

§ 371 Date: Apr. 11, 2013

(30) Foreign Application Priority Data
Sep. 20, 2010 (KR) 10-2010-0092326

(51) Int. Cl. A47L 9/00

(52) U.S. Cl. CPC A47L 9/009
USPC 134/18; 15/319

(57) ABSTRACT

Disclosed are a cleaning robot system and its method for controlling which make it possible to reliably and quickly clean with the aid of the cleaning robot. The cleaning robot system comprises at least one external device each formed of an indicator and a virtual wall setting function, with the aid of which cleaning work can be performed by the unit of blocks about a cleaning area reference point, not leaving non-cleaned area behind. Since the access of the cleaning robot can be restricted by means of a virtual wall set by an external device, any damages of furniture due to a collision of the cleaning robot can be prevented, and the cleaning robot can be barred from escaping from the set cleaning area.

### TECHNICAL FIELD

The present invention relates to a cleaning robot system and its method for controlling, and in particular to a cleaning robot system and its method for controlling which make it possible to more efficiently clean using a cleaning robot in such a manner that cleaning reference points and a traveling restriction area can be easily recognized with the aid of an external device having an indicator and a virtual wall setting function.

### BACKGROUND ART

Moving around along a programmed cleaning way a cleaning robot generally cleans the dusts or foreign substances within a set cleaning area.

The cleaning robot is inherently programmed to suck and clean the dusts or foreign substances within a set cleaning area, while recognizing a certain obstacle with the aid of a sensor.

The cleaning robot generally performs a cleaning operation, while traveling on the basis of a set cleaning pattern, sometimes, like a reciprocation operation in a zigzag form during a time duration set by a user with respect to the entire cleaning area.

The conventional cleaning robot needs information concerning a cleaning area for an efficient cleaning work, but does not have such information, due to which reasons the cleaning robot routinely performs cleaning while traveling only within a time duration set by a user without recognizing surrounding situations.

When time duration set by a user is not enough to clean a previously set cleaning area, the cleaning work might not be properly finished. When time direction set by a user is too much enough to clean a previously set cleaning area the cleaning robot might clean the cleaned areas again, which results in a lower operation efficiency.

When a conventional cleaning robot meets a certain obstacle ahead or around in the course of its cleaning, the cleaning robot is not programmed to avoid such obstacle, thus leaving the area around the obstacle non-cleaned after cleaning is finished.

### DISCLOSURE OF INVENTION

### Technical Problem

Accordingly, it is an object of the present invention to provide a cleaning robot system and its method for controlling which overcomes the problems encountered in a conventional art in which since a conventional robot system is programmed to clean only within a time duration set by a user without using any information concerning an area to be cleaned, cleaning is not properly performed, thus lowering cleaning efficiency, and in which a cleaning robot system cleans, detouring a certain obstacle, thus leaving non-cleaned area behind in the course of cleaning.

### Solution to Problem

To achieve the above objects, there is provided a cleaning robot system which comprises at least one external device having an indicator and a virtual wall setting function.

### Advantageous Effects of Invention

According to the present invention, the cleaning robot system comprises at least one external device having an indicator and a virtual wall setting function, so a cleaning operation is performed by the unit of blocks about a cleaning area reference point, thus not leaving non-cleaned area behind, as a result of which cleaning can be perfectly finished.

Since an access of a cleaning robot to a certain thing ahead can be barred by means of a virtual wall set by an external device, it is possible to prevent furniture or something from being damaged by a cleaning robot, while barring a cleaning robot from traveling beyond a set cleaning area.

### BRIEF DESCRIPTION OF DRAWINGS

The present invention will become better understood with reference to the accompanying drawings which are given only by way of illustration and thus are not limitative of the present invention, wherein;

FIG. 1 is a view illustrating the major elements of the system according to the present invention;

FIG. 2 is a schematic block diagram of a cleaning robot of a system according to the present invention;

FIG. 3 is a schematic block diagram of an external device of a system according to the present invention;

FIG. 4 is a flowchart of a control method according to the present invention;

FIG. 5 is a detailed flowchart of a robot cleaning step in a control method according to the present invention;

FIG. 6 is a detailed flowchart of a virtual wall setting step in a control method according to the present invention;

FIG. 7 is a flowchart of a wakeup operation step in a control method according to the present invention;

FIG. 8 is a detailed flowchart of a wakeup operation in a control method according to the present invention; and

FIG. 9 is a detailed flowchart of a robot cleaning step further having an identification code recognition cleaning step in a control method according to the present invention.

### MODE FOR THE INVENTION

The preferred embodiments of the present invention will be described with reference to the accompanying drawings.

The present invention is basically directed to a cleaning robot which makes it possible to reliably and definitely clean, allowing a cleaning robot to recognize a cleaning area reference point and an access restriction area of a cleaning robot, and any damages to furniture or something or escapes from a set cleaning area can be prevented.

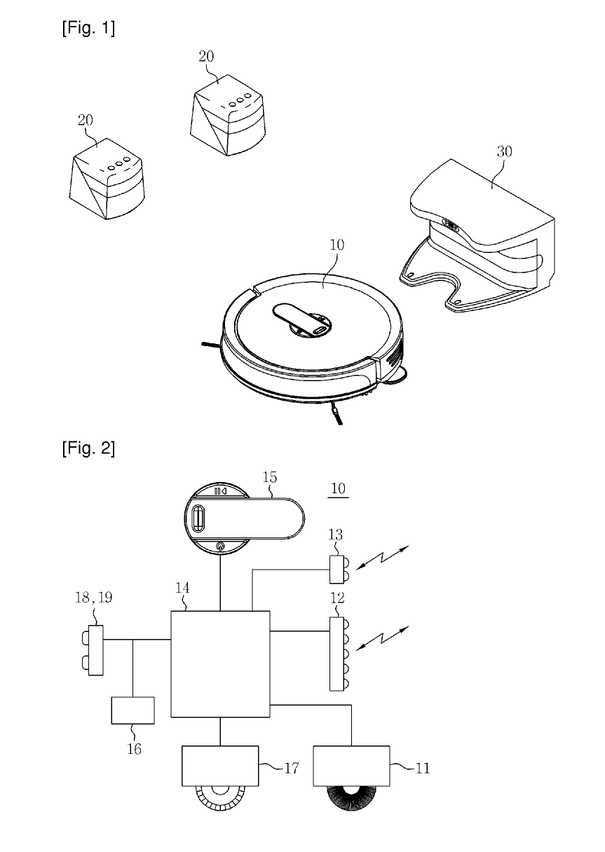

As shown in FIG. 1, the system according to the present invention comprises a cleaning robot 10 which automatically travels detouring a certain obstacle and sucks and cleans dusts and foreign substances, at least one external device 20 which has an indicator and a virtual wall setting function for allowing the cleaning robot 10 to recognize a cleaning reference point and a traveling restriction area, and a charging part 30 which electrically charges the cleaning robot 10.

As shown in FIG. 2, the cleaning robot 10 comprises a cleaning part 11 sucking and cleaning dusts and foreign substances in a set cleaning area, a driving part 17 for driving the cleaning robot 10 to travel, an obstacle detection part 12 detecting a certain obstacle in the course of traveling, a transceiver part 13 transmitting and receiving with an external device 20 and a charging part 30, a robot control part 14 controlling the operation of each element, a robot operation part 15 inputting an operation signal of a user into the robot control part 14, and a robot power part 16 supplying an electric power for the operation of the cleaning robot 10.

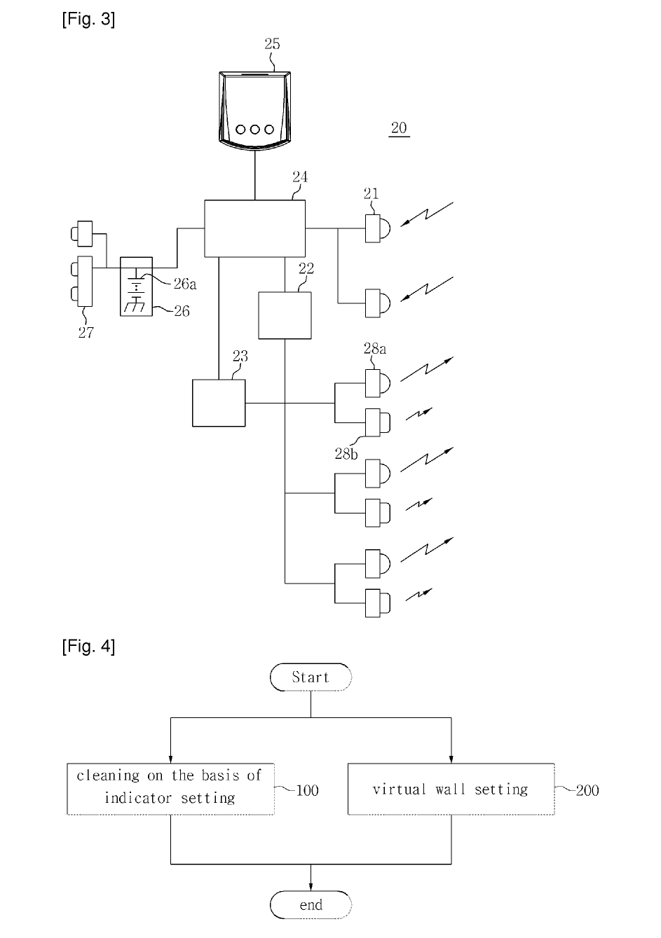

As shown in FIG. 3, the external device 20 comprises a robot signal receiving part 21 receiving a robot signal to be transmitted to the cleaning robot 10, an indicator signal control part 22 creating a signal of a cleaning area reference point to the cleaning robot, a virtual wall signal control part 23 creating a virtual wall signal which informs the cleaning robot of a traveling restriction area, an external device control part 24 controlling the operations of the robot signal receiving part 21, the indicator signal control part 22 and the virtual wall signal control part 23, an external device operation part 25 allowing a user to input a set value into the external device control part 24, an external device power part 26 supplying an external power for the operation of the system, and an external device transceiver part generating a signal in response to the signals created by the indicator signal control part 22 and the virtual wall signal control part 23.

Here, the external device transceiver part comprises an external device remote transceiver part 28a guiding the cleaning robot 10 by transmitting a signal to the same, and an external device local area transceiver part 28b providing an accurate position signal for preventing a collision of the cleaning robot 10 when it comes closer to a certain obstacle. The external device remote transceiver part 28a is formed of a remote optical sensor capable of sensing 1-5 m, and the external device local area transceiver part 28b is formed of a local area optical sensor capable of sensing within 30 cm.

Here, the external device transcriber part is preferably installed at a front side, a left side and a right side, respectively, thus effectively transmitting and receiving signals in three directions.

In a preferred embodiment of the present invention, the external device 20 might be equipped with an external device robot charging part allowing the external device 20 to be elastically charged by means of the cleaning robot 10.

The external device robot charging part is characterized in that the external device power part 26 is formed of a secondary battery 26a, and an external device charging connection part 18 is formed at an outer surface of the body of the cleaning robot 10, and a robot connection charging part 27 is formed at an outer surface of the body of the external device 20.

The external device charging connection part 18 might be used as the robot charging connection part 19 and vice versa.

The control operations of the present invention will be described.

As shown in FIG. 4, in a control method of a cleaning robot system which is formed of a cleaning robot 10 which automatically sucks and cleans dusts and foreign substances; at least one external device 20 transmitting an indicator and a virtual wall setting function; and a charging part 30 which electrically charges the cleaning robot 10, a control method of a cleaning robot system comprises a robot cleaning step 100 transmitting an indicator signal informing that an external device 20 indicates a cleaning area, so the cleaning robot 10 cleans the cleaning area by the unit of blocks; and a virtual wall setting step 200 transmitting a virtual wall signal so that the external device 20 allows the cleaning robot 10 to recognize an access restriction area in the robot cleaning step 100.

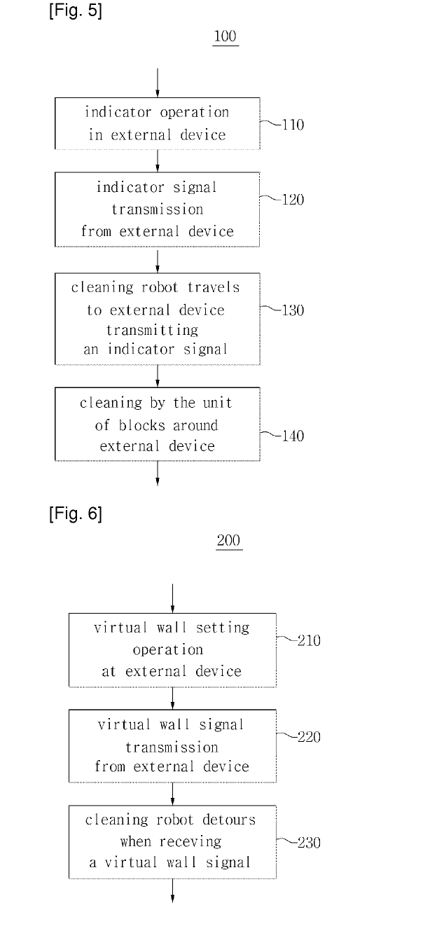

As shown in FIG. 5, the robot cleaning step 100 comprises an indicator operation step 110 allowing the external device 20 to perform an indicator operation as a user operates the external device operation part 25 of the external device; an indicator signal transmission step 120 allowing the external device having been set for the indicator operation via the indicator operation step 110 to transmit an indicator signal; a cleaning robot traveling step 130 allowing the cleaning robot 10 to receive a signal via the indicator signal transmission step 120 and to travel; and a block unit cleaning step 140 allowing the cleaning robot to move a cleaning area recognized by the external device 20 in the cleaning robot traveling step 130 and perform cleaning by the unit of blocks about the indicator point.

As shown in FIG. 6, the virtual wall setting step 200 comprises a virtual wall operation step 210 allowing the external device 20 to perform a virtual wall setting operation as a user operates the external device operation part 25 of the external device 20;

a virtual wall signal transmission step 220 allowing the external device 20 having been set for the virtual wall setting operation via the virtual wall operation step 210 to transmit a virtual wall signal; and a cleaning robot avoidance traveling step 230 allowing the cleaning robot 10 to detour a virtual wall when the cleaning robot 10 reaches the virtual wall set via the virtual wall signal transmission step 220 and receives a virtual wall signal.

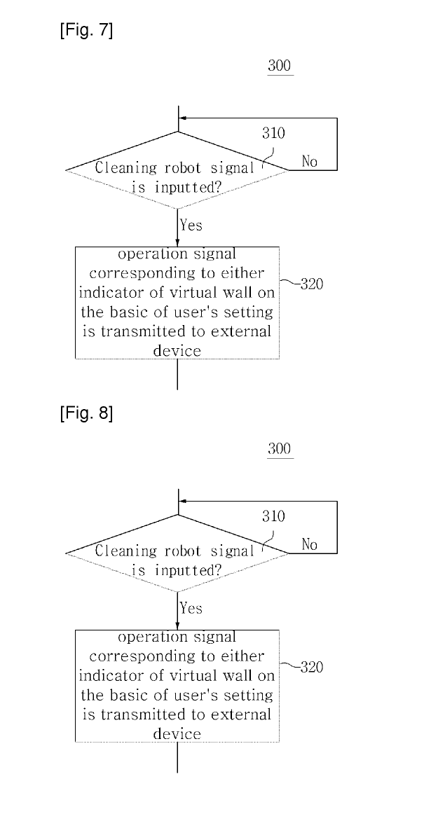

As an another embodiment of the present invention, as shown in FIG. 7, there is further provided a wakeup operation step 300 selectively transmitting either an indicator or a virtual wall signal in accordance with a user's operation as the external device 20 operates only when the cleaning robot 10 accesses.

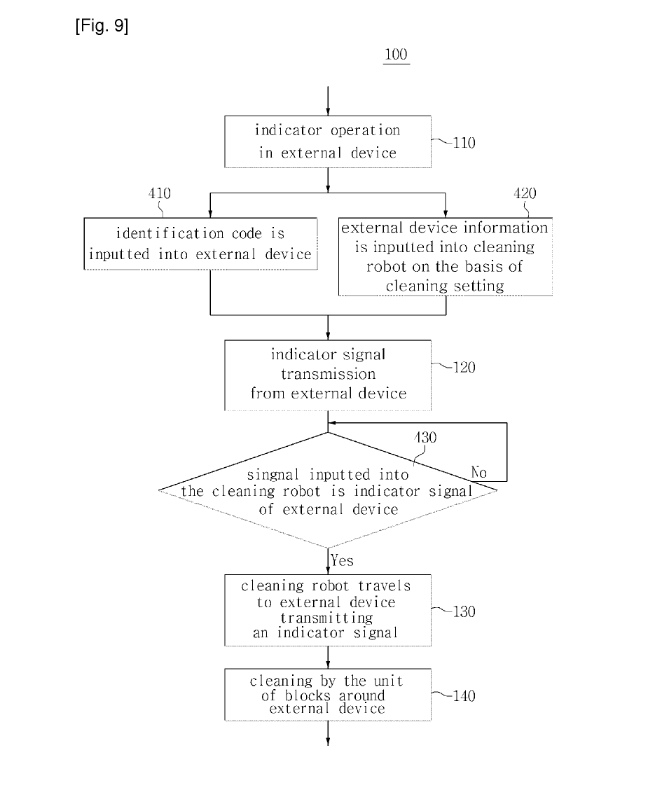

As shown in FIG. 8, the wakeup operation step 300 comprises a robot signal transmission step 310 transmitting a robot signal while the cleaning robot 10 is traveling; and a wakeup step 320 allowing the external device 20 to operate in response to an indicator or a virtual set by a user's operation, with the external device 20 having received the signal transmitted via the robot signal transmission step 310.

In addition, in the indicator signal transmission step 120, the external device is allowed to transmit an identification code, and the cleaning robot 10 recognizes the external device 20 of the cleaning area on the basis of the user's setting, thus performing an identification code recognition cleaning step.

As shown in FIG. 9, the identification code recognition cleaning step comprises an external device identification code input step 410 inputting an identification code into at least two external devices 20, respectively;

a cleaning setting input sep 420 inputting an identification code of the external device 20 of the cleaning area based on the user's setting into the cleaning robot 10; and

an external device identification step 430 performing the cleaning robot traveling step 130 when the signal is the indicator signal of the external device 20 based on the cleaning setting by recognizing the identification code based on the indicator signal transmitted from the external device 20 as the cleaning robot 10 travels.

Hereinafter, the cleaning steps of the cleaning robot system according to the present invention will be described in details with reference to the accompanying drawings.

When it is supposed to clean a certain cleaning by using a cleaning robot system formed of a cleaning robot 10, an external device 20 and a charging part 30, the charging part 30 is positioned at a standby place of the cleaning robot 10, and the charging part 30 is electrically connected with an electric outlet disposed on a wall or somewhere else.

Here, engaged with the charging part 30 the cleaning robot 10 remains in the charging mode or the work standby mode.

The external device 20 is located in an area to be cleaned. An indicator signal is transmitted to call the cleaning robot 10 by operating the external device operation part 25.

When the indicator signal is transmitted from the external device 20 on the basis of the user's operation in a state that the installation of the cleaning robot system according to the present invention is completed, the cleaning robot 10 being in the standby mode at the charging part 30 moves toward the area where transmits an indicator signal, namely, toward the area where is to be cleaned and where the external device 20 transmitting the indicator signal is positioned on the basis of the robot cleaning step 100 and then cleans the area by the unit of blocks like a go board about the external device 20.

When there is expensive furniture or something to be protected from a collision by the cleaning robot 10 in the cleaning area in the course of cleaning according to the present invention or it is needed to prevent the cleaning robot 10 from escaping from the set area, at least two external devices 20 are prepared, and the user operates the external device operation part 25 of the external device 20 with the aid of the virtual wall setting step 200, thus transmitting to the cleaning robot 10 a virtual wall setting signal which restricts further access and traveling.

In a state that a virtual wall is set via the virtual wall setting step 200, when the cleaning robot 10 working on cleaning comes closer to a set virtual wall, the cleaning robot 10 stops accessing the set virtual wall on the basis of the virtual wall signal and stops traveling and then keeps traveling detouring the set virtual wall, according to which the expensive furniture or something can be protected from a collision of the cleaning robot 10. The cleaning robot 10 is prevented from accessing or traveling to where the cleaning robot 10 might fall down or is not supposed to travel.

The wakeup operation step in the course of cleaning by the cleaning robot system according to the present invention will be described.

In the wakeup operation step in which the cleaning robot 10 wakes up only when the external device 20 receives a signal of the cleaning robot 10 and then transmits either an indicator signal or a virtual wall signal, moving for cleaning work on the basis of the user's operation, the cleaning robot 10 in the standby mode at the charging part 30 transmits a robot signal.

While the cleaning robot 10 is transmitting a robot signal and is traveling, when the external device 20 being closer to the cleaning robot 10 receives the robot signal, the external device 20 remaining in the standby mode transmits either an indicator signal or a virtual wall signal on the basis of the user's setting, and then the cleaning robot 10 selects either the robot cleaning step 100 or the virtual wall setting step 200 in response to the signal from the external device 200.

The identification code recognition cleaning step in which an identification code is transmitted to the external will be described.

In the cleaning robot system which is formed of a cleaning robot 10, an external device 20 and a charging part 30, the external device 20 is provided at each cleaning area. In this state, when cleaning is performed by a cleaning robot system which is programmed to transmit an indicator signal along with an identification signal, each external device 20 is set to transmit different identification codes (for example, no 1, no 2, no 3, . . . no n) on the basis of the user's operation and the cleaning robot 10 is set on the basis of the top priority of the plurality of the external devices 20 in response to the user's operation.

In a state that the external devices 20 each have different identification codes, and the cleaning robot 10 is set by a user, and then the cleaning robot 10 starts traveling to clean, when the plurality of the external devices 20 transmit indicator signals, the cleaning robot 10 moves toward the external device 20 transmitting the signal corresponding to the top priority among the plurality of the signals from the external devices, thus performing cleaning.

The cleaning steps based on the wakeup operation step 300 can be selectively performed in the course of the identification code recognition cleaning steps.

### INDUSTRIAL APPLICABILITY

As described above, the present invention is basically directed to performing cleaning by the unit of blocks about a cleaning area reference point by providing at least one external device having an indicator function, thus not leaving non-cleaned area behind.

Since the external device is equipped with a virtual wall setting function, an access of a cleaning robot to a set virtual wall can be restricted, according to which furniture or something expensive can be protected from damaging due to collision by a cleaning robot, while preventing the cleaning robot from escaping from the set cleaning area in the course of cleaning.

In addition, since the external device is designed to operate on the basis of the wakeup operation step, the external device can be in the standby mode, not communicating with the cleaning robot, which leads to minimizing the consumption of electric power.

Since the external device transmits an indicator signal along with an identification code, the cleaning area can be set based on the user's selection, thus more efficiently performing cleaning.

The external device is equipped with a robot connection charging part, and the cleaning robot is equipped with an external deice charging connection part, so the electric charging of the external device can be performed with the aid of the cleaning robot, whereby the external devices can be installed where there is not any external electric power supply.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A cleaning robot system, comprising:
a cleaning robot 10 which automatically sucks and cleans dusts and foreign substances, while avoiding and detouring a certain obstacle ahead;
at least one external device 20 which has an indicator and a virtual wall setting function for allowing the cleaning robot 10 to recognize a cleaning reference point and a traveling restriction area; and
a charging part 30 which electrically charges the cleaning robot 10,
wherein said cleaning robot 10 includes:
a cleaning part 11 sucking and cleaning dusts and foreign substances in a cleaning area;
a driving part 17 driving the cleaning robot 10;
an obstacle detection part 12 detecting a certain obstacle in the course of traveling;
a transceiver part 13 communicating with the external devices 20 and the charging part 30;
a robot control part 14 controlling the operations of each element;
a robot operation part 15 inputting an user's operation signal into the robot control part 14; and
a robot power part 16 supplying electric power for the operations of the cleaning robot 10; and
wherein said external devices 20 each include:
a robot signal receiving part 21 receiving a robot signal transmitted to the cleaning robot 10;
an indicator signal control part 22 creating a signal of a cleaning area reference point to the cleaning robot;
a virtual wall signal control part 23 creating a virtual wall signal informing the cleaning robot of a traveling restriction area;
an external device control part 24 controlling the operations of the robot signal receiving part 21, the indicator signal control part 22 and the virtual wall signal control part 23;
an external device operation part 25 helping input a user's set value into the external device control part 24;
an external device power part 26 supplying electric power for the operations of elements; and an external device transceiver part transmitting a signal in response to the signals transmitted from the indicator signal control part 22 and the virtual wall signal control art 23.

2. The system of claim 1, wherein said external device transceiver part comprise an external device remote transceiver part 28a performing a guidance by transmitting a signal to a remotely located cleaning robot 10; and
an external device local transceiver part 28b preventing a collision of the cleaning robot 10 coming closer to a certain obstacle and providing a definite position signal, with said external device transceiver part being installed at a front side, a left side and a right side, respectively, thus transmitting signals in three directions.

3. The system of either claim 1, wherein said external devices 20 each include an external device robot charging means foe charging with the aid of the cleaning robot 10, and said external device robot charging means is characterized in that the external device power part 26 is formed of a rechargeable secondary battery 26a, with an external device charging connection part 18 being provided at an outer surface of the body of the cleaning robot 10, with a robot connection charging part 27 being provided at an outer surface of the body of the external device 20.

4. In a control method of a cleaning robot system which is formed of a cleaning robot 10 which automatically sucks and cleans dusts and foreign substances; at least one external device 20 transmitting an indicator and a virtual wall setting function; and a charging part 30 which electrically charges the cleaning robot 10, a control method of a cleaning robot system, comprising:
a robot cleaning step 100 transmitting an indicator signal informing that an external device 20 indicates a cleaning area, so the cleaning robot 10 cleans the cleaning area by the unit of blocks; and
a virtual wall setting step 200 transmitting a virtual wall signal so that the external device 20 allows the cleaning robot 10 to recognize an access restriction area in the robot cleaning step 100.

5. The method of claim 4, wherein said robot cleaning step 100 comprises:
an indicator operation step 110 allowing the external device 20 to perform an indicator operation as a user operates the external device operation part 25 of the external device;
an indicator signal transmission step 120 allowing the external device having been set for the indicator operation via the indicator operation step 110 to transmit an indicator signal;
a cleaning robot traveling step 130 allowing the cleaning robot 10 to receive a signal via the indicator signal transmission step 120 and to travel; and
a block unit cleaning step 140 allowing the cleaning robot to move a cleaning area recognized by the external device 20 in the cleaning robot traveling step 130 and perform cleaning by the unit of blocks about the indicator point.

6. The method of claim 4, wherein said virtual wall setting step 200 comprises:
a virtual wall operation step 210 allowing the external device 20 to perform a virtual wall setting operation as a user operates the external device operation part 25 of the external device 20;
a virtual wall signal transmission step 220 allowing the external device 20 having been set for the virtual wall setting operation via the virtual wall operation step 210 to transmit a virtual wall signal; and
a cleaning robot avoidance traveling step 230 allowing the cleaning robot 10 to detour a virtual wall when the cleaning robot 10 reaches the virtual wall set via the virtual wall signal transmission step 220 and receives a virtual wall signal.

7. The method of claim 4, further comprising:
a wakeup operation step 300 selectively transmitting either an indicator or a virtual wall signal in accordance with a user's operation as the external device 20 operates only when the cleaning robot 10 accesses, said wakeup operation step 300 comprising:
a robot signal transmission step 310 transmitting a robot signal while the cleaning robot 10 is traveling; and
a wakeup step 320 allowing the external device 20 to operate in response to an indicator or a virtual set by a user's operation, with the external device 20 having received the signal transmitted via the robot signal transmission step 310.

8. The method of claim 4, wherein in said indicator signal transmission step 120, the external device is allowed to transmit an identification code, and the cleaning robot 10 recognizes the external device 20 of the cleaning area on the basis of the user's setting, thus performing an identification code recognition cleaning step, wherein said identification code recognition cleaning step comprises:
an external device identification code input step 410 inputting an identification code into at least two external devices 20, respectively;
a cleaning setting input sep 420 inputting an identification code of the external device 20 of the cleaning area based on the user's setting into the cleaning robot 10; and
an external device identification step 430 performing the cleaning robot traveling step 130 when the signal is the indicator signal of the external device 20 based on the cleaning setting by recognizing the identification code based on the indicator signal transmitted from the external device 20 as the cleaning robot 10 travels.

9. The system of claim 2, wherein said external devices 20 each include an external device robot charging means foe charging with the aid of the cleaning robot 10, and said external device robot charging means is characterized in that the external device power part 26 is formed of a rechargeable secondary battery 26a, with an external device charging connection part 18 being provided at an outer surface of the body of the cleaning robot 10, with a robot connection charging part 27 being provided at an outer surface of the body of the external device 20.
